(19) United States
(12) Patent Application Publication
(10) Pub. No.: US 2012/0162566 A1
(43) Pub. Date: Jun. 28, 2012

(54) TELEVISION AND ELECTRONIC APPARATUS

(75) Inventor: Tsuyoshi SHIMOMICHI, Fuchu-shi (JP)

(73) Assignee: KABUSHIKI KAISHA TOSHIBA, Tokyo (JP)

(21) Appl. No.: 13/227,368

(22) Filed: Sep. 7, 2011

(30) Foreign Application Priority Data
Dec. 27, 2010 (JP) 2010-290999

(51) Int. Cl. G02F 1/1333; F21V 8/00

(52) U.S. Cl. 349/58; 362/611; 362/612

(57) ABSTRACT

According to one embodiment, a television comprises a housing which includes a metal front cover provided with an opening, and a metal back cover combined with the front cover. The housing houses therein a liquid crystal panel which comprises a display surface exposed from the opening, a light guide plate which faces the liquid crystal panel in the rear of the liquid crystal panel, and a light source module which applies light to the light guide plate from the periphery of the light guide plate. A frame which surrounds the light guide plate is housed between the front cover and the back cover. The frame comprises a metal light source support which supports the light guide plate and to which the light source module is thermally connected. The front cover, the back cover, and the frame are linked via a fixing member.

### CROSS-REFERENCE TO RELATED APPLICATIONS

This application is based upon and claims the benefit of priority from Japanese Patent Application No. 2010-290999, filed Dec. 27, 2010; the entire contents of which are incorporated herein by reference.

### FIELD

Embodiments described herein relate generally to a television and an electronic apparatus equipped with backlight devices.

### BACKGROUND

A liquid crystal television as an example of an electronic apparatus is equipped with a backlight device in the rear of a liquid crystal panel. The backlight device is assembled as one module, and is housed in a synthetic resin housing together with the liquid crystal panel.

Liquid crystal televisions that use light-emitting diodes as light sources of backlight devices instead of fluorescent tubes have been commercialized. The liquid crystal television of this type needs to be separately provided with a frame that supports a light guide plate of the backlight device, and a heat sink for releasing heat generated by the light-emitting diodes. Accordingly, a space for housing the frame and the heat sink have to be ensured inside the housing. This makes it difficult to meet recent demands for thinner and more compact liquid crystal televisions.

Moreover, it cannot be denied that the heat release performance of the heat sink deteriorates because the heat sink is covered with the housing.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary front view of a liquid crystal television according to an embodiment;

FIG. 2 is an exemplary side view of the liquid crystal television according to the embodiment;

FIG. 3 is an exemplary perspective view showing, in an exploded form, a general television body of the liquid crystal television shown in FIG. 1;

FIG. 4 is an exemplary perspective view of a light source module used in the liquid crystal television; and

FIG. 5 is an exemplary sectional view taken along the line F5-F5 of FIG. 1.

### DETAILED DESCRIPTION

Various embodiments will be described hereinafter with reference to the accompanying drawings. In general, according to one embodiment, a television comprises a housing which includes a metal front cover provided with an opening, and a metal back cover combined with the front cover. The housing houses therein a liquid crystal panel which comprises a display surface exposed from the opening, a light guide plate which faces the liquid crystal panel in the rear of the liquid crystal panel, and a light source module which applies light to the light guide plate from the periphery of the light guide plate. A frame which surrounds the light guide plate is housed between the front cover and the back cover. The frame comprises a metal light source support which supports the light guide plate and to which the light source module is thermally connected. The front cover, the back cover, and the frame are linked via a fixing member.

An embodiment is described below with reference to the drawings.

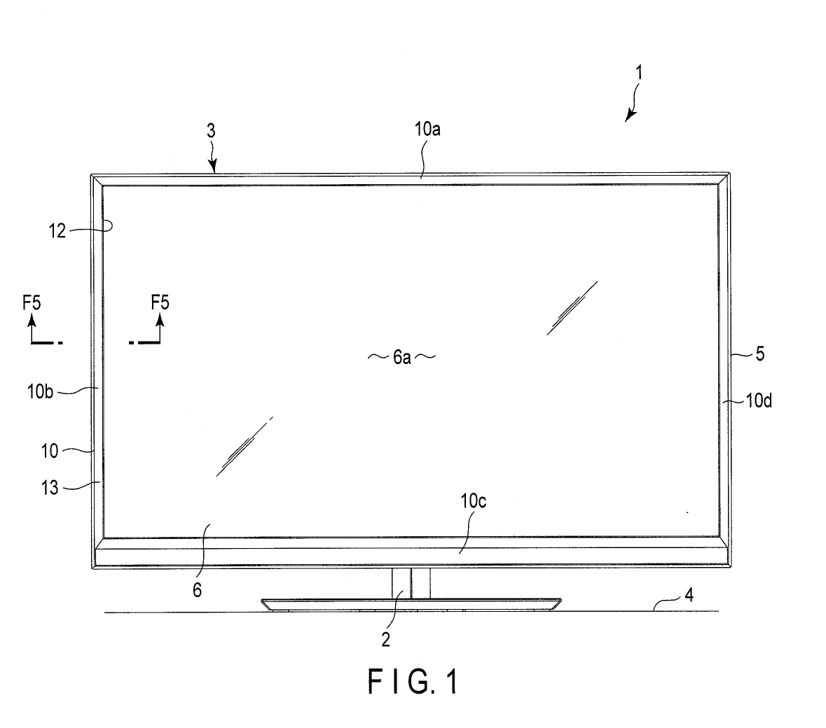

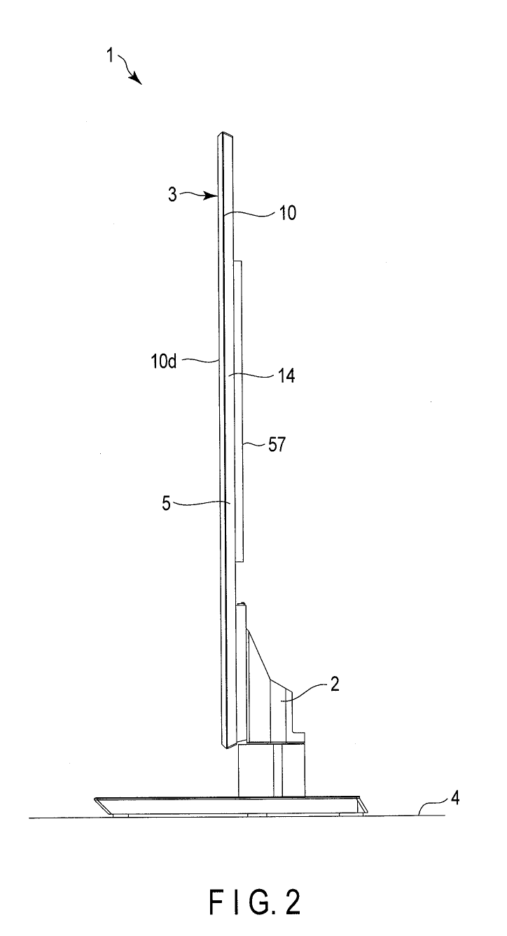

FIG. 1 and FIG. 2 show a liquid crystal television 1 which is one example of an electronic apparatus. The liquid crystal television 1 comprises a table stand 2 and a television body 3. The table stand 2 is placed on, for example, a placement surface 4 of a television stand, and supports the television body 3.

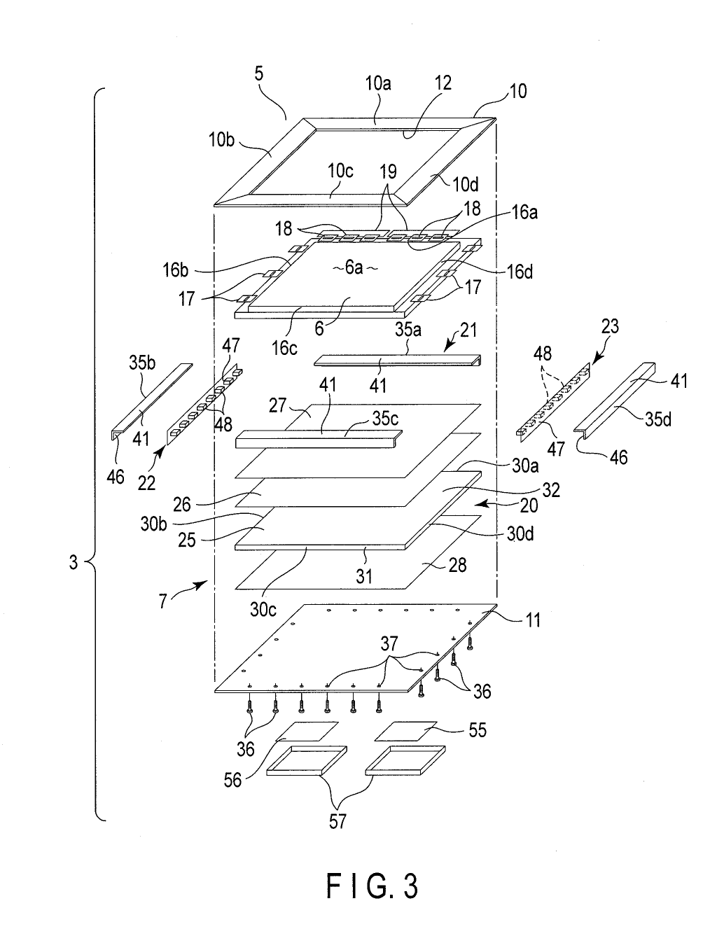

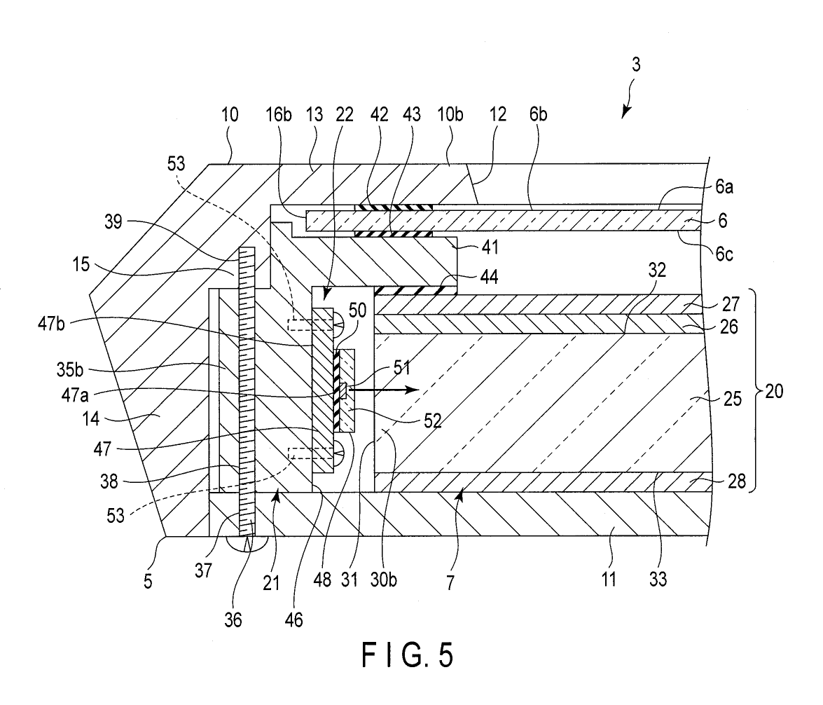

As shown in FIG. 3 and FIG. 5, the television body 3 comprises a housing 5, a liquid crystal panel 6, and a backlight device 7. The housing 5 comprises a front cover 10 and a back cover 11. The front cover 10 is one example of a first metal cover, and has first to fourth edges 10a, 10b, 10c, and 10d. The first to fourth edges 10a, 10b, 10c, and 10d each comprise, for example, an extruded elongate molded article made of an aluminum alloy. The first and third edges 10a and 10c extend parallel to each other in the width direction of the front cover 10. The second and fourth edges 10b and 10d extend parallel to each other in the height direction of the front cover 10. Therefore, the first to fourth edges 10a, 10b, 10c, and 10d are combined together into a square frame shape, and cooperate with one another to define a square opening 12.

The first to fourth edges 10a, 10b, 10c, and 10d have a common sectional shape. FIG. 5 shows an exemplary sectional shape of the second edge 10b. As shown in FIG. 5, each of the first to fourth edges 10a, 10b, 10c, and 10d has a front wall 13 and a peripheral wall 14. The front wall 13 defines one side of the opening 12, and configures the front surface of the housing 5. The peripheral wall 14 extends from the outer peripheral edge of the front wall 13 in a direction that intersects at right angles with the front wall 13, and configures the peripheral surface of the housing 5.

Furthermore, each of the first to fourth edges 10a, 10b, 10c, and 10d has a corner 15 defined by the front wall 13 and the peripheral wall 14. The corner 15 projects to the inside of the front cover 10.

The back cover 11 is one example of a second metal cover. The back cover 11 is a square plate made of, for example, aluminum alloy, and is located opposite to the front cover 10 across the opening 12. The front cover 10 and the back cover 11 are combined together to configure a flat square box/shaped housing 5.

The liquid crystal panel 6 is one example of a display panel, and is housed in the housing 5. The liquid crystal panel 6 has liquid crystal included between stacked two glass plates. The liquid crystal panel 6 includes a first surface 6b having a square display surface 6a, and a second surface 6c located opposite to the first surface 6b. The display surface 6a is exposed to the outside of the housing 5 from the opening 12 of the front cover 10.

As shown in FIG. 3, the liquid crystal panel 6 has first to fourth edges 16a, 16b, 16c, and 16d surrounding the display surface 6a. The first and third edges 16a and 16c extend parallel to each other in the width direction of the liquid crystal panel 6. The second and fourth edges 16b and 16d extend parallel to each other in the height direction of the liquid crystal panel 6.

The entire length of each of the first and third edges 16a and 16c is greater than the entire length of each of the second and fourth edges 16b and 16d. In the present embodiment, the length proportion of each of the first and third edges 16a and 16c to each of the second and fourth edges 16b and 16d is set to, for example, 16:9.

Furthermore, the liquid crystal panel 6 includes gate drivers 17, source drivers 18, and source substrates 19. The gate drivers 17, the source drivers 18, and the source substrates 19 are arranged around the liquid crystal panel 6 in a dispersed form.

As shown in FIG. 3 and FIG. 5, the backlight device 7 is positioned in the rear of the liquid crystal panel 6 inside the housing 5. The backlight device 7 comprises a light guide 20, a frame 21, a first light source module 22, and a second light source module 23.

The light guide 20 is configured by stacking a light guide plate 25, a prism sheet 26, a polarizing sheet 27 and a reflection sheet 28 on one another. The light guide plate 25 is a square transparent plate having a size corresponding to the liquid crystal panel 6. The light guide plate 25 faces the second surface 6c of the liquid crystal panel 6 in the rear of the liquid crystal panel 6.

The light guide plate 25 has first to fourth edges 30a, 30b, 30c, and 30d. The first and third edges 30a and 30c extend parallel to each other in the width direction of the light guide plate 25. The second and fourth edges 30b and 30d extend parallel to each other in the height direction of the light guide plate 25. Moreover, each of the first to fourth edges 30a, 30b, 30c, and 30d has a peripheral surface 31. The peripheral surface 31 links a front surface 32 and a rear surface 33 of the light guide plate 25, and is exposed to the periphery of the light guide plate 25.

The prism sheet 26 is stacked on the front surface 32 of the light guide plate 25. The polarizing sheet 27 is stacked on the prism sheet 26, and faces the second surface 6c of the liquid crystal panel 6. The reflection sheet 28 is stacked on the rear surface 33 of the light guide plate 25, and faces the back cover 11.

As shown in FIG. 3, the frame 21 has first to fourth supports 35a, 35b, 35c, and 35d. The first to fourth supports 35a, 35b, 35c, and 35d each comprise, for example, an extruded elongate molded article made of an aluminum alloy, and have a common sectional shape.

The first and third supports 35a and 35c extend parallel to each other in the width direction of the light guide plate 25. The second and fourth supports 35b and 35d extend parallel to each other in the height direction of the light guide plate 25. The first to fourth supports 35a, 35b, 35c, and 35d are combined together into a square frame shape to continuously surround the light guide plate 25 in the circumferential direction.

As shown by the exemplar second support 35b of the frame 21 in FIG. 5, each of the first to fourth supports 35a, 35b, 35c, and 35d of the frame 21 intervenes between the corner 15 of the front cover 10 and the back cover 11 and is thus covered with the front cover 10 and the back cover 11.

The front cover 10, the back cover 11, and the frame 21 are joined together via first screws 36. The first screws 36 are one example of a fixing member, and are arranged at intervals in the circumferential direction of the front cover 10 and the frame 21.

The first screws 36 are passed through first screw insertion holes 37 made in the outer peripheral portion of the back cover 11 and second screw insertion holes 38 made in the frame 21 from the rear of the housing 5, and are screwed into screw holes 39 provided in the corner 15 of the front cover 10.

As a result, the front cover 10 and the back cover 11 are coupled to each other, and the frame 21 is held between the front cover 10 and the back cover 11. Thus, the frame 21 is thermally connected to the front cover 10 and the back cover 11.

Each of the first to fourth supports 35a, 35b, 35c, and 35d of the frame 21 comprises a panel holding portion 41 as shown in FIG. 5. The panel holding portions 41 protrude from the first to fourth supports 35a, 35b, 35c, and 35d of the frame 21 between the liquid crystal panel 6 and the light guide 20. Thus, the outer peripheral portion of the liquid crystal panel 6 intervenes between the front wall 13 of the front cover 10 and the panel holding portions 41. Likewise, the outer peripheral portion of the light guide 20 intervenes between the back cover 11 and the panel holding portions 41.

According to the present embodiment, a first insulator 42 is located between the front wall 13 of the front cover 10 and the outer peripheral portion of the liquid crystal panel 6. The first insulator 42 comprises, for example, a rubber sheet, and thermally insulates the front cover 10 and the liquid crystal panel 6 from each other.

A second insulator 43 is located between the panel holding portion 41 of the frame 21 and the outer peripheral portion of the liquid crystal panel 6. The second insulator 43 comprises, for example, a rubber sheet, and thermally insulates the frame 21 and the liquid crystal panel 6 from each other.

Furthermore, a third insulator 44 is located between the panel holding portion 41 of the frame 21 and the light guide 20. The third insulator 44 comprises, for example, a rubber sheet, and thermally insulates the frame 21 and the light guide 20 from each other.

Each of the second support 35b of the frame 21 located on the left side of the light guide 20 and the fourth support 35d of the frame 21 located on the right side of the light guide 20 is one example of a light source support. Each of the second support 35b and the fourth support 35d has a heat receiving surface 46 as shown in FIG. 5. The heat receiving surface 46 is a flat surface facing the peripheral surface 31 of the light guide plate 25, and extends parallel to the peripheral surface 31 of the light guide plate 25.

The first light source module 22 and the second light source module 23 are light sources for increasing the visibility of an image displayed on the display surface 6a of the liquid crystal panel 6. The first light source module 22 is fixed to the heat receiving surface 46 of the second support 35b of the frame 21, and faces the left peripheral surface 31 of the light guide plate 25. The second light source module 23 is fixed to the heat receiving surface 46 of the fourth support 35d of the frame 21, and faces the right peripheral surface 31 of the light guide plate 25.

The first and second light source modules 22 and 23 have a common configuration. Therefore, the first light source module 22 located on the left side of the light guide plate 25 is described as an exemplar.

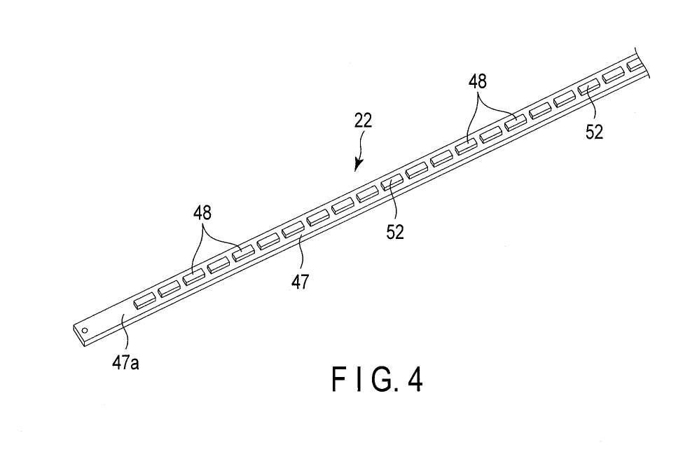

As shown in FIG. 4 and FIG. 5, the first light source module 22 comprises a base 47 and light emitting portions 48. The base 47 comprises, for example, an extruded elongate molded article made of an aluminum alloy, and extends straight along the peripheral surface 31 of the light guide plate 25. The base 47 has a first surface 47a, and a second surface 47b located opposite to the first surface 47a. Each of the first and second surfaces 47a and 47b is a flat surface.

The light emitting portions 48 are aligned at intervals in the longitudinal direction of the base 47. As shown in FIG. 5, each of the light emitting portions 48 comprises a multilayer substrate 50, a light-emitting diode 51, and a sealing agent 52. The multilayer substrate 50 is bonded onto the first surface 47a of the base 47. The light-emitting diode 51 is one example of a light-emitting element, and is mounted in the center of the surface of the multilayer substrate 50. The sealing agent 52 is made of a transparent resin material including a fluorescent material, and is stacked on the surface of the multilayer substrate 50 to cover the light-emitting diode 51.

The first light source module 22 is attached to the heat receiving surface 46 of the frame 21 in such a posture that the light emitting portions 48 are directed toward the peripheral surface 31 of the light guide plate 25. More specifically, the base 47 having the light emitting portions 48 is fixed to the heat receiving surface 46 of the frame 21 via second screws 53. As a result, the second surface 47b of the base 47 is brought into close contact with the heat receiving surface 46 so that the first light source module 22 is thermally connected to the frame 21.

As shown in FIG. 3, a circuit board 55 for driving the liquid crystal panel 6 and a control substrate 56 for driving the backlight device 7 are supported on the back cover 11. The circuit board 55 and the control substrate 56 are covered with shield cases 57, respectively. The shield cases 57 are attached to the back cover 11 and exposed in the rear of the housing 5.

Now, a procedure of assembling the television body 3 is described.

First, the first to fourth edges 10a, 10b, 10c, and 10d are combined together to form the square frame-shaped front cover 10. In this condition, the front cover 10 is held horizontal so that the peripheral wall 14 of the front cover 10 stands, and the liquid crystal panel 6 is placed in a predetermined position of the inner surface of the front wall 13 via the first insulator 42.

The first to fourth supports 35a, 35b, 35c, and 35d are then combined together to form a square frame 21. Moreover, the first light source module 22 is fixed to the heat receiving surface 46 of the second support 35b of the frame 21 via the second screws 53. Likewise, the second light source module 23 is fixed to the heat receiving surface 46 of the fourth support 35d of the frame 21 via the second screws 53.

The frame 21 combined with the first and second light source modules 22 and 23 is then fitted into the front cover 10. As a result, the panel holding portion 41 of the frame 21 is superposed on the outer peripheral portion of the liquid crystal panel 6 via the second insulator 43. At the same time, the first to fourth supports 35a, 35b, 35c, and 35d of the frame 21 are butted against the corner 15 of the front cover 10. Further, the light emitting portions 48 of the first and second light source modules 22 and 23 face each other in the width direction of the front cover 10 inside the front cover 10.

The outer peripheral portion of the light guide 20 is then superposed on the panel holding portion 41 of the frame 21 via the third insulator 44. As a result, the light guide 20 is positioned between the first light source module 22 and the second light source module 23.

Furthermore, the back cover 11 is laid over the front cover 10, and the back cover 11 is superposed on the first to fourth supports 35a, 35b, 35c, and 35d of the frame 21 and the light guide 20.

After this, the first screws 36 are screwed into the screw holes 39 of the front cover 10 from the first screw insertion holes 37 of the back cover 11 through the second screw insertion holes 38 of the frame 21. As a result, the front cover 10, the back cover 11, and the frame 21 are joined together. At the same time, the frame 21 is held between the front cover 10 and the back cover 11, and is thermally connected to the front cover 10 and the back cover 11.

Finally, the circuit board 55, the control substrate 56, and the shield cases 57 are attached to the back cover 11, thereby completing the assembly of the television body 3.

According to the liquid crystal television 1 having such a configuration, light emitted from the light-emitting diodes 51 of the first and second light source modules 22 and 23 enters the light guide plate 25 from the peripheral surface 31 of the light guide plate 25 as indicated by an arrow in FIG. 5. The light which has entered the light guide plate 25 penetrates the prism sheet 26 and the polarizing sheet 27 and then travels to the liquid crystal panel 6.

Furthermore, of the light which has entered the light guide plate 25, the light traveling to the back cover 11 is reflected by the reflection sheet 28, and then penetrates the prism sheet 26 and the polarizing sheet 27 and travels to the liquid crystal panel 6. Therefore, the light is applied to the liquid crystal panel 6 from the light guide plate 25, and the visibility of an image displayed on the display surface 6a of the liquid crystal panel 6 is increased.

Heat emitted by the light-emitting diodes 51 is transmitted to the base 47 via the multilayer substrate 50, and also transmitted to the first and third supports 35a and 35c of the frame 21 from the base 47. The base 47 and the frame 21 are both made of an aluminum alloy having a high heat conducting performance. Thus, the heat of the light-emitting diodes 51 is efficiently diffused to the frame 21 from the base 47.

In addition, the frame 21 is integrally joined to the front cover 10 and the back cover 11 that constitute the housing 5, and thus thermally connected to the front cover 10 and the back cover 11. The front cover 10 and the back cover 11 are both made of an aluminum alloy having a high heat conducting performance. Thus, the heat of the light-emitting diodes 51 diffused to the frame 21 is efficiently conveyed from the frame 21 to the front cover 10 and the back cover 11.

The front cover 10 and the back cover 11 are exposed to the outside of the television body 3 and are therefore appearance elements of the liquid crystal television 1. Therefore, the heat of the light-emitting diodes 51 can be released to the atmosphere from the front cover 10 and the back cover 11.

As a result, both the front cover 10 and the back cover 11 can be utilized as heat sinks, and the heat of the light-emitting diodes 51 is not easily retained in the housing 5. Thus, thermal effects on the liquid crystal panel 6 are lessened, and high-quality images can be obtained.

Moreover, in the present embodiment, the liquid crystal panel 6 and the front cover 10 are thermally insulated from each other by the first insulator 42, and the liquid crystal panel 6 and the frame 21 are thermally insulated from each other by the second insulator 43. Therefore, while the heat of the light-emitting diodes 51 is actively conveyed to the front cover 10 and the frame 21, thermal effects on the liquid crystal panel 6 can be minimized. This is also advantageous in obtaining high-quality images.

Furthermore, in order to obtain high-quality images, the frame 21 surrounding the light guide plate 25 is preferably painted black. This permits the frame 21 to absorb most of the light guided to the frame 21 from the light guide plate 25. Thus, variation in the luminance of the display surface 6a of the liquid crystal panel 6 can be prevented.

In addition, in the present embodiment, the frame 21 which cooperates with the back cover 11 to support the light guide 20 is made of a metal material such as an aluminum alloy. Thus, the frame 21 functions to support the light guide 20, and also functions as a heat sink to release the heat of the light-emitting diodes 51. As a result, there is no need for an exclusive heat sink, so that the number of components of the television body 3 can be reduced, and the space for housing the heat sink can be eliminated in the housing 5.

Consequently, the housing 5 and thus the television body 3 can be more reduced in thickness to increase the commercial value of the liquid crystal television 1.

Furthermore, the first screws 36 for coupling the front cover 10 to the back cover 11 penetrate the frame 21. According to this configuration, the frame 21 can be held between the front cover 10 and the back cover 11 and thereby firmly fixed.

Moreover, the frame 21 can be fixed to the housing 5 by use of the first screws 36 for coupling the front cover 10 to the back cover 11. Therefore, there is no need for exclusive screws to fix the frame 21 to the housing 5, and the number of components of the television body 3 can be reduced.

In addition, the first screws 36 penetrating the frame 21 function as heat transmission paths for transferring the heat of the light-emitting diodes 51 transmitted to the frame 21 to the front cover 10 and the back cover 11. The first screws 36 can be used to actively dissipate the heat of the light-emitting diodes 51 from the frame 21 to the front cover 10 to the back cover 11.

The frame is not exclusively formed by combining the first to fourth supports together, and may be, for example, integrally molded into a square frame shape.

The first support and the third support of the frame out of the first and second light source modules are not exclusively made of a metal. For example, if the heat emitted from the first light source module and the second light source module can be sufficiently released from the second support and the fourth support, the first support and the third support can be made of a resin.

Furthermore, the electronic apparatus is not exclusively a liquid crystal television. The electronic apparatus could be another apparatus; for example, a monitor of a desktop computer, a display module of a portable computer, or an electronic book reader.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A television comprising:
a housing comprising a metal front cover and a metal back cover, the metal front cover comprising an opening, and the metal back cover mechanically coupled with the metal front cover;
a liquid crystal panel in the housing, the liquid crystal panel comprising a display surface exposed in the opening;
a light guide plate in the housing, the light guide plate facing the rear of the liquid crystal panel;
a light source module configured to apply light to the light guide plate from the periphery of the light guide plate; and
a frame between the front cover and the back cover, the frame around the light guide plate, the frame comprising a metal light source support configured to support the light guide plate, the light source module thermally coupled to the light guide plate; and
a fixing member mechanically coupling the front cover, the back cover, and the frame.

2. The television of claim 1, wherein the light source module comprises a metal base, the metal base configured to support light-emitting elements, the light emitting elements configured to generate heat, the metal base thermally connected to the light source support.

3. The television of claim 2, wherein the base of the light source module is along the edge of the light guide plate, and the light-emitting elements are aligned in the longitudinal direction of the base.

4. The television of claim 3, wherein the light source support of the frame comprises a surface configured to receive heat, the heat receiving surface facing the peripheral surface of the light guide plate, and the base of the light source module is mechanically coupled to the heat receiving surface.

5. The television of claim 4, wherein the front cover and the back cover and hold the frame therebetween.

6. The television of claim 5, wherein the frame comprises a panel holding portion between the outer peripheral portion of the liquid crystal panel and the outer peripheral portion of the light guide plate, and wherein when the fixing member links the front cover, the back cover, and the frame, the outer peripheral portion of the liquid crystal panel is between the panel holding portion and the front cover, and the outer peripheral portion of the light guide plate is between the panel holding portion and the back cover.

7. The television of claim 6, further comprising a first insulator between the front cover and the liquid crystal panel, a second insulator between the liquid crystal panel and the panel holding portion, and a third insulator between the light guide plate and the panel holding portion.

8. An electronic apparatus comprising:
a housing comprising a first metal cover and a second metal cover, the second metal cover mechanically coupled with the first metal cover;
a display panel in the housing; and
a backlight device in the housing in the rear of the display panel, the backlight device comprising a light guide plate facing the display panel, a light source module configured to apply light to the light guide plate from the periphery of the light guide plate, and a metal light source support configured to support the light guide plate and to which the light source module is thermally coupled, the light source support linked to the first metal cover and the second metal cover via a fixing member.

9. The electronic apparatus of claim 8, wherein the light source module includes a metal base and light-emitting diodes, the light-emitting diodes supported by the base, the base fixed to the light source support.

10. The electronic apparatus of claim 9, wherein the base of the light source module is along the edge of the light guide plate, and the light-emitting diodes are aligned in the longitudinal direction of the base.

11. The electronic apparatus of claim 10, wherein the light source support comprises a surface configured to receive heat, the heat receiving surface facing the peripheral surface of the light guide plate, and the base of the light source module mechanically coupled to the heat receiving surface.

12. The electronic apparatus of claim 11, wherein the light source support comprises a panel holding portion between the outer peripheral portion of the display panel and the outer peripheral portion of the light guide plate, the outer peripheral portion of the display panel between the panel holding portion and the first metal cover, and the outer peripheral portion of the light guide plate between the panel holding portion and the second metal cover.

13. The electronic apparatus of claim 12, further comprising a first insulator between the first metal cover and the display panel, a second insulator between the display panel and the panel holding portion, and a third insulator between the light guide plate and the panel holding portion.

14. An electronic apparatus comprising:
a housing comprising a first metal cover and a second metal cover mechanically coupled with the first metal cover;
a display panel in the housing, the display panel comprising a first surface and a second surface, the first surface comprising a display surface exposed in the housing, and the second surface opposite the first surface;
a light guide plate in the housing, the light guide plate facing the second surface of the display panel;
a light source module configured to apply light to the light guide plate from the periphery of the light guide plate;
a metal support configured to support the light guide plate in the housing, the light source module thermally connected to the metal support; and
a fixing member mechanically coupling the first metal cover, the second metal cover, and the support.

15. The electronic apparatus of claim 14, wherein the support comprises a panel holding portion around the light guide plate, the panel holding portion in the housing, and the panel holding portion between the outer peripheral portion of the display panel and the outer peripheral portion of the light guide plate, and wherein the outer peripheral portion of the display panel is between the panel holding portion and the first metal cover, and the outer peripheral portion of the light guide plate is between the panel holding portion and the second metal cover.

16. The electronic apparatus of claim 15, wherein a portion of the fixing member is within the support, a portion of the fixing member between the first metal cover and the second metal cover.
